(19) United States
(12) Patent Application Publication
(10) Pub. No.: US 2026/0130747 A1
(43) Pub. Date: May 14, 2026

(54) APPARATUSES AND METHODS FOR DISPLAYING THE POSITION OF A DENTAL FILE DURING ENDODONTIC TREATMENT

(71) Applicant: DENTSPLY SIRONA Inc., York, PA (US)

(72) Inventors: Johannes Ulrici, Darmstadt (DE); Bjoem Voss, Bensheim (DE); Hong Keun Kim, Frankfurt (DE); Simone Hieber, Baden (CH); Konrad Klein, Heidelberg (DE); Michael Elvers, Darmstadt (DE)

(73) Assignee: DENTSPLY SIRONA Inc., York, PA (US)

(21) Appl. No.: 18/942,955

(22) Filed: Nov. 11, 2024

(51) Int. Cl. A61C 19/04; A61C 5/42; A61C 9/00; G06T 7/00; G06T 7/60; G06T 7/73; G06T 17/00

(52) U.S. Cl. CPC A61C 19/041; A61C 5/42; A61C 9/0046; G06T 7/0012; G06T 7/60; G06T 7/75; G06T 17/00; G06T 2200/04; G06T 2207/10116; G06T 2207/20036; G06T 2207/30036; G06T 2207/30204; G06T 2210/41

(57) ABSTRACT

Apparatuses and methods are provided for displaying the position of a dental file during endodontic treatment. Data showing the morphology of a tooth is obtained. In one embodiment, the data is X-ray image data. A three-dimensional representation of the dental file positioned in the tooth is generated, and a length that the dental file extends from an upper surface of the tooth is determined from the three-dimensional representation. A representation of the dental file is provided in the image of the tooth obtained from the data showing the tooth morphology, with the representation of the dental file being depicted such that a part of the representation of the dental file extends from the upper surface of the tooth in proportion to the length that the dental file extends from the upper surface of the tooth as determined from the three-dimensional representation and such that a remaining part of the representation of the dental file extends into the tooth, with a part of the remaining part of the representation of the dental file being positioned in the root of the tooth in the image. The image of tooth and representation of the dental file may be displayed.

### BACKGROUND

### Field of the Invention

Embodiments of the invention relate to apparatuses and methods for displaying the position of a dental file during endodontic treatment.

### Related Art

Endodontic treatment, commonly known as a root canal treatment, is a dental procedure aimed at treating the inside of a tooth, specifically addressing issues within the pulp chamber and root canals. Pulp is soft tissue inside a tooth containing blood vessels, nerves, and connective tissue. When the pulp becomes infected or inflamed due to factors such as deep decay, repeated dental procedures, or trauma, endodontic treatment becomes necessary to save the tooth.

During a root canal procedure, the dental professional removes the infected or damaged pulp, cleans the interior of the tooth, and shapes the root canals. The space left after the pulp is removed, is then filled with a biocompatible material, and the tooth is sealed to prevent further infection. Following the root canal procedure, a dental crown may be used to restore the tooth's strength and function.

To clean and shape the narrow and curved canals within a tooth's root, the dental professional uses a file. Proper positioning of the dental file is essential for the success of the root canal procedure. That is, accuracy in determining the file's position is vital to ensure thorough cleaning, shaping, and disinfection of the root canal system, ultimately leading to the successful restoration of the tooth's health. Thus, the dental professional must carefully determine the position of the file.

Often, to accurately determine the position of the file in the root canal, an x-ray is taken after the file is inserted. But due to the setup and available instruments, at many offices where endodontic treatments are performed the patient must move from the treatment chair to a different location for taking the x-ray to determine the file position in the root of the tooth. This disturbs the workflow for the dental professional and may be unsettling and uncomfortable for the patient. Moreover, taking an x-ray for the sole purpose of determining the position of dental file is not ideal for the patient given that it is best to avoid x-ray exposure as much as possible in view of the risks associated with cumulative exposure to ionizing radiation (ALARA principle).

As an alternative to using x-rays to determine file positioning, there are apex locator devices that can be used with the dental file to determine the working length of the inserted file. See, e.g., Nekoofar, M.H., The fundamental operating principles of electronic root canal length measurement devices, 39 Int. Endodontic J. 595(2006 ). However, such techniques require a dedicated device for only this aspect of the endodontic treatment procedure, and the devices cannot be used with all patients, for example, these devices are not recommended for patients having an implanted cardiac pacemaker.

### SUMMARY OF THE INVENTION

According to one embodiment of the invention, a method of providing an image depicting a representation of a dental file extending into a root of a tooth is disclosed. The method comprises obtaining data showing morphology of the tooth; generating a three-dimensional representation of the dental file positioned in the tooth; determining from the three-dimensional representation a length that the dental file extends from a top surface of the tooth; providing a representation of the dental file in an image of the tooth generated from the data showing the morphology of the tooth, with the representation of the dental file being depicted in the image such that a part of the representation of the dental file extends from the top surface of the tooth in proportion to the length that the dental file extends from the top surface of the tooth determined from the three-dimensional representation and such that a remaining part of the representation of the dental file extends into the tooth, with a part of the remaining part of the representation of the dental file being positioned in the root of the tooth in the image; and displaying the image of tooth and representation of the dental file.

According to another embodiment of the invention, an apparatus provides an image depicting a representation of a dental file positioned in a root of a tooth. The apparatus includes at least one processor configured to read out and execute instructions stored in at least one memory to thereby cause the apparatus to function as: a receiving unit configured to receive (i) data showing the morphology of the tooth, the two-dimensional image including a root of the tooth, and (ii) a three-dimensional representation of a dental file and the tooth; a file position determining unit configured to determine from the three-dimensional representation a length that the dental file extends from an upper surface of the tooth; and an image generation unit configured to provide a representation of the dental file in an image of the tooth, with the representation of the dental file being depicted such that a part of the representation of the dental file extends from the upper surface of the tooth in proportion to the length that the dental file extends from the upper surface of the tooth as determined from the three-dimensional representation and such that a remaining part of the representation of the dental file extends into the tooth, with a part of the remaining part of the representation of the dental file being positioned in the root of the tooth.

### BRIEF DESCRIPTION OF THE DRAWINGS

FIG. 1 is an X-ray image of a dental file positioned in a root canal.

FIG. 2 is a schematic diagram of a system according to embodiments of the invention.

FIG. 3 illustrates a digital impression scan of a tooth with a file inserted.

FIGS. 4(a) and 4(b) show a dental file and its use according to embodiments of the invention.

FIG. 5 shows an X-ray image and a representation of a dental file according to an embodiment of the invention.

FIG. 6 is a flow chart showing steps of a methods according to embodiments of the invention.

### DETAILED DESCRIPTION OF THE INVENTION

Embodiments of the invention will now be described. The embodiments include apparatuses and methods for displaying a depiction showing the position of a dental file during endodontic treatment.

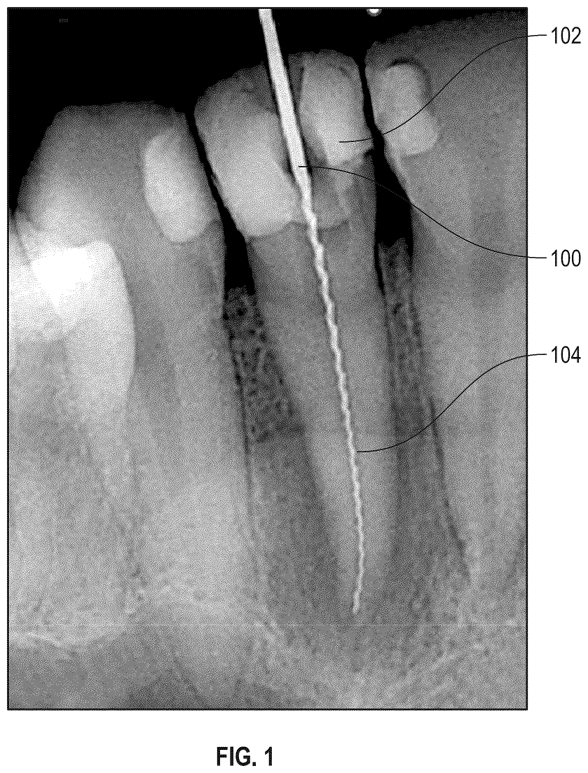

As discussed above, the proper positioning of a dental file in a tooth's root is a necessary part of a successful endodontic treatment. As also discussed above, a dental professional will often consult an X-ray showing the positioning of the dental file in the root canal to ensure that proper positioning of the dental file has been achieved. FIG. 1 shows such an X-ray wherein a dental file 100 is positioned in a tooth 102 during an endodontic treatment. An extent of the dental file 100 is positioned above the surface of the tooth and an extent of the dental file 100 is positioned in the root 104 of the tooth 102.

The X-ray shown in FIG. 1 was taken during the endodontic procedure after the dental file 100 has been inserted into the root 104. In many settings, to obtain such an X-ray the patient would need to move from the treatment chair to another location where the X-ray machine for taking the X-ray is located. This is undesirable as it can be disruptive for the dental professional and may be unsettling and uncomfortable for the patient to move in the middle of the procedure. It is also preferable to avoid subjecting humans to X-ray radiation whenever possible, and, thus, not ideal for an X-ray to be taken for the sole purpose of determining the position of a file during an endodontic treatment.

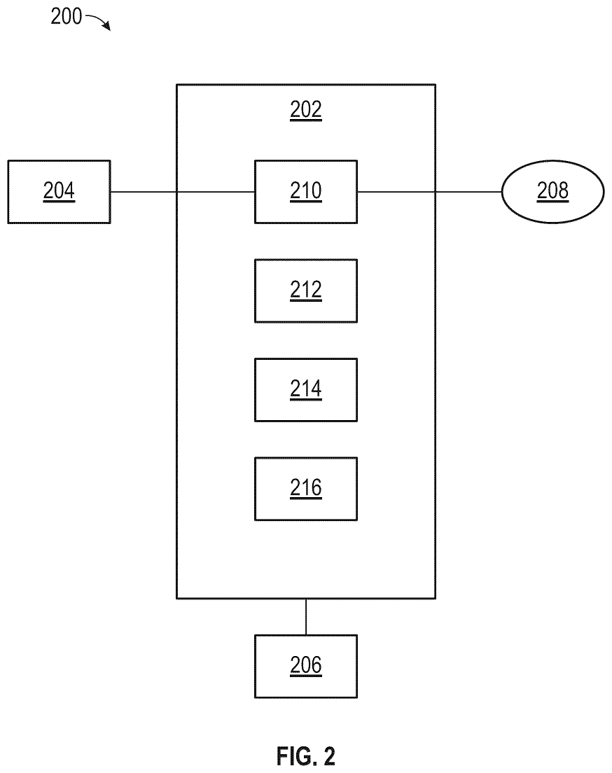

To provide a representation similar to that shown in FIG. 1, but without any need for a patient to be subject to an X-ray during the treatment, systems and methods according to embodiments of the invention may be used. FIG. 2 is a schematic diagram of such a system, which will now be described.

The system 200 shown in FIG. 2 includes a computer 202 that is operatively linked to an intra-oral scanning device 204 and a display device 206.

Those skilled in the art will recognize different types of intraoral scanners that can be used to form three-dimensional representations of teeth and dental files in conjunction with embodiments of the invention. In embodiments of the invention, the intraoral scanner 204 is a digital impression (DI) scanner. A DI scanner is a non-invasive device that uses optical technologies to create a three-dimensional digital model of the patient's dentition. During the scanning process, the dentist or dental professional moves the handheld scanner over the patient's teeth and surrounding tissues, allowing the device to capture comprehensive data. The DI scanner uses light to record the contours and surface details, producing a highly accurate digital representation of the oral anatomy.

The computer 202 that receives scanning data from the intra oral scanner 204 may be a general or special purpose computer. Such computers will typically include a central processing unit (CPU) that includes at least one processor. Such computers will also typically include additional processing structures, such as graphical processor of a graphical processing unit (GPU). The one or more processors are coupled to one or more memory structures, which may be random access memory (RAM) devices, cache memories, non-volatile or backup memories, read-only memories, etc. In addition, memory may be considered to include memory storage physically located elsewhere in computer, e.g., any cache memory in a processor, as well as any storage capacity used as a virtual memory, e.g., as stored on a mass storage device or on another computer coupled to the computer 202.

The computer 202 will also typically include at least one communication interface comprising a number of input and output components for communicating with external devices. Such a communication interface can be provided with a wide variety of technologies. For example, the communication interface components may be operable to couple the computer 202 to a network or devices. The communication interface may include wired communication components, wireless communication components, cellular communication components, Near Field Communication (NFC) components, BLUETOOTH® components, WIFI® components, and other communication components to provide communication via other modalities.

The computer 202 further includes a data storage device. The data storage device is configured to record data persistently, where “persistently” or “persistent” refers as to a device's ability to maintain recorded data after loss of power. In some embodiments, the data storage device may correspond to non-disk storage media. For example, the data storage device may be one or more solid-state drives (SSDs), flash memory-based storage, any type of solid-state non-volatile memory, or any other type of non-mechanical storage device. In other implementations, the data storage device may include mechanical or spinning hard disk, such as hard-disk drives (HDD).

As an alternative to including the data storage device, or in addition to the data storage device, in embodiments, the computer 202 is operatively linked to a data storage device that is physically separated from the structure of computer 202. For example, an input/output component of the communication interface of the computer 202 may be connected to a network through which the computer 202 receives data from an external data storage device.

It should be noted that a distributed computer system could be used to provide the functions of the computer 202 described herein. One example of a distributed computer system is a cloud-based architecture. As will be appreciated by those skilled in the art, cloud computing is the delivery of services—such as servers, storage, databases, networking, software, analytics, and intelligence—over the internet (“the cloud”). As an example of a cloud computing embodiment of the invention, a server computer could receive the data from the intraoral scanner 204 and the computer 202 could be client that accesses the scanning data from the server.

The computer 202 is operatively connected to a display device 206 for displaying images as described herein. The computer 202 may also include another user interface (not shown) incorporating one or more user input devices (e.g., a keyboard, a mouse, a trackball, a joystick, a touch pad, and/or a microphone, among others). The display device 206 and/or other user interface allows a user to control operation of the computer 202. In other embodiments, the computer 202 is operatively linked to another device providing such a user interface. For example, the computer 202 may be connected to a network to which a remote workstation with a user interface is provided. Still other embodiments of the invention may combine functions of the user interface and the display device 206, such as in a touch-screen device.

The computer 202 operates under the control of an operating system and executes or otherwise relies upon various computer software applications, components, programs, objects, units, data structures, etc., as will be described in detail below. Moreover, various applications, components, programs, objects, units, etc. may also execute on one or more processors in another computer coupled to computer 202 via a network, e.g., as in a distributed computer system, whereby the processing required to implement the functions of a computer program may be allocated to multiple computers over a network.

The operative link provided between the computer 202 and the intraoral scanner 204 allow the computer 202 to receive data from the scanner 204 for generating three-dimensional representations of oral areas and structures, e.g., dental files, in the oral area. The computer may be operatively linked to other systems to receive further data 208 for use in conjunction with embodiments of the invention. For example, the computer 202 may be operatively linked to a two-dimensional image generating system such as an X-ray generating system (not shown) and/or an external storage device linked to the computer 202 (e.g., through a network) storing data showing the morphology of one of more teeth. Thus, the computer 202 can receive the data showing morphology of the teeth.

In the description below, the computer 202 will primarily be described as using two-dimensional image data to generate images of dental files positioned in the previously generated X-ray images. However, embodiments of the invention are not limited to using X-ray data. In other embodiments, the computer could receive other types of data that shows the morphology of teeth. For example, the data could be obtained by digital volume tomography (DVT), tomosynthesis, magnetic resonance imaging (MRI), or acoustic imaging. As will be appreciated by those skilled in the art, such examples are capable of generating data for the morphology of teeth that can be used in embodiments of the invention.

The intraoral scanner 204, other systems, and the computer 202 may be formed with a direct physical connection such that the operative link(s) is in the form of a wire structure that transmits the data and/or control commands between the computer 202 and the intraoral scanner 204. In other embodiments, the computer 202, intraoral scanner 204, and other systems are connected through a network, such as local area network (LAN), a wireless local area network (WLAN), or through the Internet. Those skilled in the art will appreciate the wide variety of ways that the computer 202 may be operatively linked to other systems.

In still other embodiments, the computer 202, intraoral scanner 204, and any other systems are provided as a singular hardware structure. That is, the computer 202 is directly built integrated with the intraoral scanner 204.

Embodiments of the invention include functional units that reside in memory device(s) of the computer 202. Each of the units is computer-executable code that, when executed by the computer's processors, imparts the unit's functionality to the computer 202. Those skilled in the art will recognize the coding languages and techniques that may be used to create the units. Units according to embodiments of the invention will now be described.

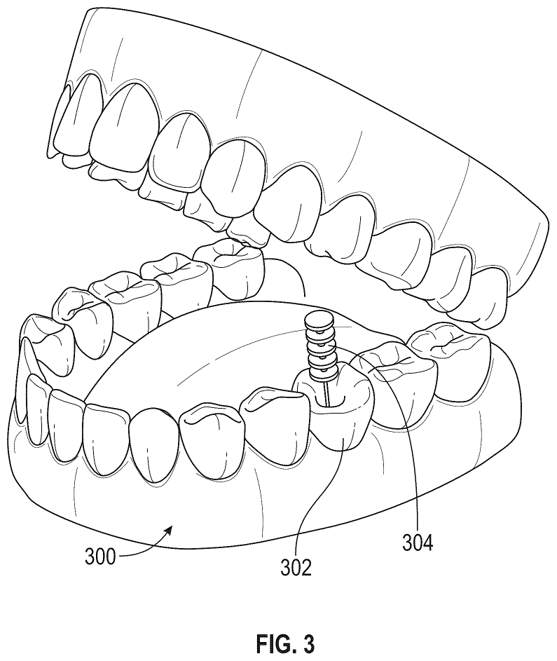

The computer 202 includes a receiving unit 210 that receives data for a three-dimensional representation of the patient's dentition from the intraoral scanner 204. The three-dimensional representation received by the computer 202 may be stored in a memory. In conjunction with an endodontic procedure, the three-dimensional representation includes at least one tooth and the dental file extending from an upper surface of the tooth. An example of such an image generated from such a three-dimensional representation is illustrated in FIG. 3. The illustrations show a digital impression scan of the patient's dentition 300, including the tooth 302 to which the endodontic procedure is directed. The dental file 304 can be seen in the scan extending from the upper surface of the tooth 302.

The receiving unit 210 can also receive tooth morphology data that corresponds to the same tooth or teeth that are in the three-dimensional representation and store such data in a memory. In embodiments of the invention, data showing the tooth morphology is X-ray image data. And for convenience, the two-dimensional image data will be referred to as X-ray image data in the following descriptions. But, as noted above, the tooth morphology data may be in other forms.

It should be noted that the data showing the morphology of the tooth need not be generated and received by the receiving unit 210 contemporaneously with the receiving unit 210 receiving the data for a three-dimensional representation. Rather, the morphology data could be generated at a time before the generation of the data for a three-dimensional representation. This may be advantageous in relation to an endodontic procedure because the X-ray image can be obtained at any time in advance of the dental professional starting to operate on the patient. Thus, the patient need not, for example, be moved after the dental file placement to another location in order to generate the morphology data.

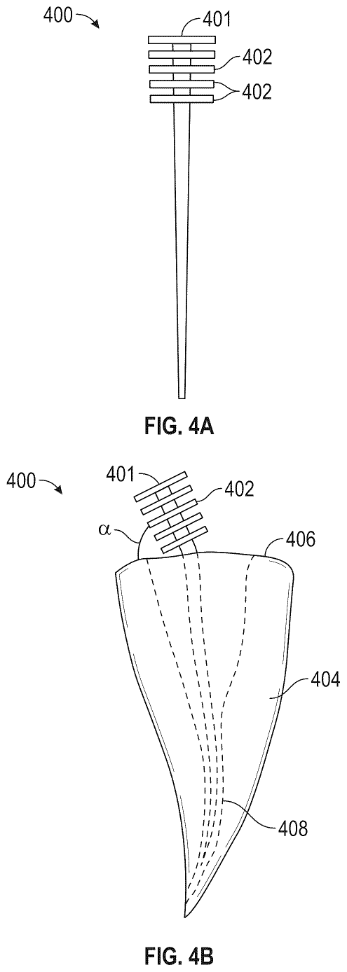

The computer 202 further includes a determining unit 212 that is configured to determine from three-dimensional representation data received by the receiving unit 210 the length the dental file extends from the upper surface of the tooth. To make this determination, the determining unit 212 is configured to recognize at least one aspect of the dental file in the three-dimensional representation. For example, a marker may be provided to the dental file. FIG. 4(a) shows an example of a dental file 400 according to embodiments of the invention, wherein the marker is in the form of shapes that can be recognized by the determining unit. Specifically, the dental file 400 includes rings 402 on side of the file that will extend from the upper surface of a tooth when the dental file 400 is positioned into a root of the tooth.

In other embodiments, the dental file may be formed in different shapes or geometries that can be recognized in the three-dimensional representation. In still further embodiments, other aspects of the dental file can be provided as indicators recognized by the determining unit 212. For example, color coding, file sizing, or symbols on the file could be used. In still other embodiments, an otherwise unmarked dental file could be segmented from the three-dimensional scan data itself to determine the length that the file extends about the upper surface of the tooth.

For convenience, in the following example the dental file 400 with rings 402 will be discussed. However, as evident from the disclosure herein, the dental file and the determination of the length of the dental file extending from the tooth is not limited to this embodiment.

As shown in FIG. 4(b), the five of the rings 402 are visible above the upper surface 406 of the tooth 404 when the dental file 400 is positioned into the root 408 of the tooth 404. The number of rings 402 that are visible above the top surface 406 of the tooth 404 is indicative of the length of the part of the dental file 400 that extends from the upper surface 406 of the tooth 504. For example, each ring 402 may correspond to a distance of one mm from an end 401 of the file. Thus, if 5 rings are shown from the upper surface of the tooth in the three-dimensional representation, then the dental file extends a distance d of 5 mm from the upper surface of the tooth.

To identify the number of rings (or other identifiable aspect) of the dental file that are visible in the dental file in the three-dimensional representation, the determining unit may use shape recognition techniques such as voxel-based segmentation or surface reconstruction. Voxel-based segmentation techniques provide for differentiation between the tooth, the dental file, and the rings that are visible, based on variations in voxel intensity, density, or other properties. Surface reconstruction techniques may create geometric representations of the tooth and dental file from which the shapes and features of the tooth and dental file can be accurately captured. Once the tooth and the dental file are delineated through segmentation, surface reconstruction, or other techniques, the determining unit can analyze their characteristics using, for example, feature extraction methods and machine learning algorithms. Those skilled in the art will appreciate the specifics of such shape recognition techniques that may be used in a determining unit according to embodiments of the invention.

The result is that the determining unit 212 determines the part of the dental file extending from the upper surface of the tooth. As such, the determining unit can determine the length of the part of the dental file extending from the upper surface of the tooth. For example, in embodiments where the dental file includes rings, if 5 rings are determined to be visible in the part of the dental file in the three-dimensional representation, and if each rings indicates a distance of 1 mm from the end of the file, then the determining unit determines that the dental file extends 5 mm from the upper surface of the tooth. By obtaining the positions of the rings and also the surface of the tooth as in this example, the portion of the file above the surface of the tooth can be obtained with sub-millimeter accuracy, e.g., by measuring the distance between the center point of the last visible ring and the intersection of the file axis with the (projected) upper surface of the tooth and adding the value to the 5 mm.

Having obtained the length of the part of the dental file extending from the upper surface of the tooth, the determining unit can also calculate the length of dental file that extends into the tooth. That is, the length that the dental file extends into the tooth is the total length of the dental file minus the length of the dental file that extends from the upper surface of the tooth. The total length of the dental file may be, for example, input to the computer 202. Then the determining unit subtracts the length of the part of the dental file from the total length to obtain the length of the part of the dental file extending into tooth.

Having segmented the tooth and the dental file as described above, the determining unit 212 can also determine an angle of the dental file relative to the upper surface of the tooth. For example, as shown in FIG. 4(b), the dental file is positioned at an angle a relative to the surface of the tooth. This angle may be measured by the determining unit 212 in the segmented three-dimensional representation. The angle of the dental file may be used to determine which of multiple root canals of a tooth the file is inserted into. Additionally, in embodiments multimodal three-dimensional registration data can aid in determining which of the root canals that the dental file is positioned in, and, further, a dental professional can determine visually which of the root canals the dental file is positioned in using, for example, dental loupes or operating microscopes.

The computer 202 further includes a file position determining unit 214 configured to determine a position of the dental file relative to the corresponding tooth in the X-ray image (or other data showing the morphology of the tooth) that was received by the receiving unit 210, based on the determinations made by the determining unit 212. The file position determining unit 214 does this by first segmenting the tooth in the X-ray image. In this process, the file position determining unit also segments roots of the tooth in the X-ray image. Those skilled in the art will recognize, for example, algorithms designed for edge detection and feature extraction that can be applied to identify the contours and boundaries of a tooth and its roots in an X-ray image. Machine learning may be used to train the file position determining unit 214 on a dataset of annotated X-ray images to accurately recognize and segment tooth and root structures. By analyzing intensities, their gradients, and spatial relationships within the image, the algorithms can effectively isolate the teeth and their roots.

To aid in the positioning of the file in the X-ray image (or other data showing tooth morphology), the X-ray image may be correlated to the three-dimensional representation. To perform such a correlation, systems according to embodiments of the invention may be configured to determine and then match edges (also referred to as “contours”) of structures in the X-ray image with silhouette edges of structures in a rendering of the three-dimensional data. In such a process, edges in the X-ray image that may be matched to silhouette edges in the three-dimensional representation data. Possible matching edges are determined in two steps: an initial determination is made as to a number of possible edges in the X-ray image, and identified edges that will likely not be useful in the matching with the silhouette edges of the three-dimensional data are then eliminated. Thus, a subset of edges of structures in the X-ray image that can potentially be matched to edges in the three-dimensional representation are obtained.

A rough match can then be made between the X-ray image and the three-dimensional representation using one or more of known parameters of the X-ray imaging and matchings of individual teeth in the X-ray images to corresponding teeth in the three-dimensional representation. For example, metadata from the X-ray image indicating known parameters of the projection frustum (position, direction, focus angle) may be used to establish a rough initial match between the X-ray image and the three-dimensional representation. For example, when a bitewing system is used to generate the X-ray image, often the spatial extent of the detection sensor, its approximate positioning relative to the jaw, the distance range between the X-ray source and the sensor will be available, and the direction from the sensor to the X-ray source will be available. Such information limits the search space in the three-dimensional representation to primarily finding the correspondence on a line along the jaw. Alternatively, the search along the jaw curve could be done, for example, using feature matching or a grid-like search strategy.

In addition to using information from the X-ray imaging process, the rough correlation can also be determined by segmenting individual teeth and their tooth numbers both in the X-ray image and the three-dimensional representation, and then superimposing corresponding teeth in the image and representation. To do this, an algorithm may be used to segment the jaw line as well as all of the individual teeth along the jaw line in the three-dimensional data. Similarly, an algorithm can be used to identify individual teeth with their tooth numbers in the X-ray image. For identifying the teeth in both types of representations (image and three-dimensional data), the algorithms can be based on artificial intelligence techniques, such as machine learning. Such techniques may yield a bounding box for each identified tooth in the X-ray image and three-dimensional model. The rough match is thereafter obtained by matching the bounding box for one or more teeth in the X-ray image to the bounding box for the corresponding one or more teeth in the three-dimensional model.

In further embodiments of the invention, the user may provide input as to the rough match between the X-ray image and the three-dimensional representation. To do so, the image(s) and rendering(s) from the three-dimensional representation can be displayed on a display. Using an interface, the user can move, rotate, and scale the image to establish a view where the X-ray image and the rendering are roughly represented.

From the rough correlation, the correlation between the projected X-ray image and the three-dimensional representation can be progressively refined by adjusting the approximated X-ray image projection onto the three-dimensional data. To do this, silhouette edges from the three-dimensional data are determined given the current approximate position of the X-ray image. Then candidate silhouette edges are selected from amongst the determined silhouette edges to form a subset of edges that can potentially be matched to edges in the X-ray image.

To correlate the subset of silhouette edges from the three-dimensional data and the subset of edges in the X-ray image, points are selected from the candidate silhouette edges and the closest point in the edges in the X-ray image within a given maximum search radius within the rough matches are determined. The maximum search radius can be a fixed value that is empirically determined. If no corresponding point in an edge area in the X-ray image can be found for a particular selected point from the candidate silhouette edges, then the selected point is discarded. Alternatively, the correlation could be performed with a reverse process wherein edges in the X-ray image are selected and closest points from the candidate silhouette edges are determined within a maximum search radius.

Once correspondences have been found between points from the candidate silhouette edges and points in the edges in the X-ray image, an optimization algorithm is used to closely match the silhouette edges and the edges in the X-ray image. The parameters to be optimized are the virtual position of the X-ray source, the viewing direction, and the focal length. The error measure that drives the optimization is a distance measure between the correspondences of candidate silhouette and X-ray image edge points. In some embodiments of the invention, the optimization algorithm follows the Gauss-Newton method. In this method, for each correspondence of a point in a silhouette edge and a point in an edge of the X-ray image, a two-dimensional residual and the residual's Jacobian is determined with respect to all parameters are determined, and a parameter update that minimizes the sum of the squared residuals is computed and applied. If the resulting total reprojection error is below a threshold, the fine correlation ends. If the resulting error is above a threshold, a new iteration of the algorithm is started. Those skilled in the art will recognize alternative optimization algorithms that can be used in embodiments of the invention.

Further details of how an X-ray image may be correlated to three-dimensional representation data can be found in U.S. patent application Ser. No. 18/753,387, the disclosure of which is incorporated herein in its entirety. Moreover, details for the correlation from a three-dimensional X-ray volume can be found in European Patent Application EP 23218478.8, the disclosure of which is incorporated herein in its entirety.

Having determined the positioning of dental file relative to the tooth in the X-ray image, an image generation unit 216 that generates an image that includes a representation of the dental file and an image generated from the data showing the morphology of the tooth, e.g., X-ray image data. In so doing, the image generation unit 216 scales the size of the representation of the dental file to the size of the tooth. Note in this regard that the size of the segmented tooth in, for example, an X-ray image is easily determined from the known scale of the X-ray image. The image generation unit 216 positions the dental file based on the lengths and angle determined by the determining unit 212 and the positioning determined by the file position determining unit 214. That is, the image generation unit 216 forms the representation of the dental file such that the representation extends from the upper surface of the tooth in proportion to the length determined by the determining unit 212 and the angle relative to the upper surface of the tooth determined by the determining unit 212. The image generation unit 216 further positions relative to the tooth based on the positioning determined by the file position determining unit 214, with a proportional extent of the dental file being depicted in the root of the tooth in the image.

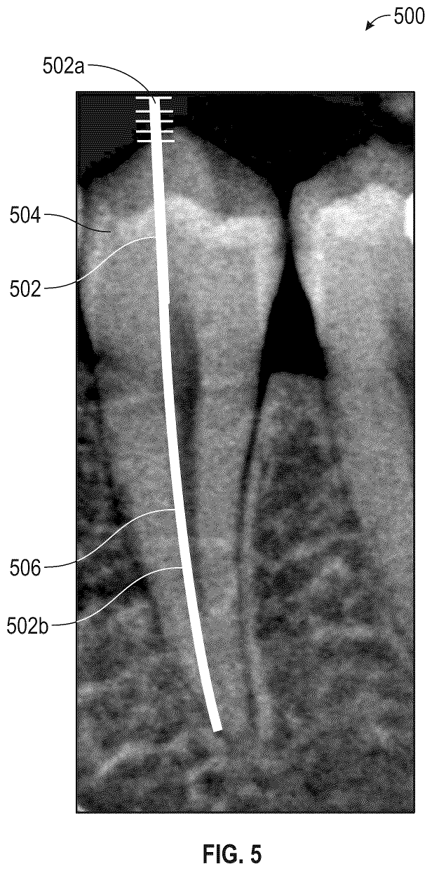

An example of such image 500 generated by an image generation unit according to an embodiment of the invention is shown in FIG. 5. The representation of the dental file 502 is depicted accurately relative to the tooth 504 and its root 506 in the image 500. That is, the representation of the dental file 502 is depicted such that a part 502a of the representation of the dental file 502 extends from the upper surface of the tooth in proportion to the length that the dental file 502 extends from an upper surface of the tooth determined from the three-dimensional representation, and a remaining part of the representation of the dental file extends into the tooth, with a part 502b of the remaining part of the representation of the dental file being positioned in the root of the tooth. The image may be displayed, for example, on the display device 206 connected to the computer 202. Thus, a dental professional can determine from the image 500 that the dental file 502 is correctly positioned based on the distance from the tip of the dental file to the apex at the end of the root of the tooth.

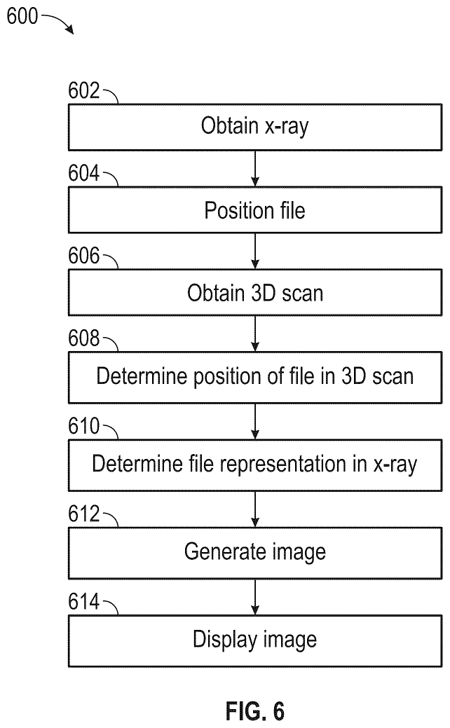

FIG. 6 is a flow chart of a method 600 according to embodiments of the invention. The method 600 may be performed, in part, by using the systems and techniques as described above. The method 600 will be described in the context that an X-ray image is used to show the morphology of the tooth, but, as discussed above, in other embodiments the data showing the tooth morphology may be in other forms.

At a step 602, a two-dimensional representation showing at least one tooth of a patient is obtained. As discussed above, in embodiments of the invention the method can be a part of an endodontic procedure and the two-dimensional representation may be an X-ray image. Those skilled in the art will recognize different types of dental X-ray machines and techniques that can be used to obtain such an image. For example, the X-ray image could be generated using an intra-oral system such as a bitewing, or the X-ray image could be generated using panoramic X-ray system or a three-dimensional x-ray image acquired with a DVT. The X-ray image obtained in step 602 can be generated at a time before the subsequent steps of the method 600 are performed.

At step 604, a dental file is positioned to the tooth such that a part of the dental file extends into a canal of the tooth and a part of the dental file extends from the upper surface of the tooth.

At step 606, a three-dimensional image of the tooth and the positioned dental file is obtained. As described above, the three-dimensional image could be obtained using an intraoral DI scanner.

At step 608, the positioning of the dental file in the three-dimensional image is determined. As discussed above, this step includes segmenting the tooth and the dental file in the three-dimensional image, determining a length of the dental file that extends from a top surface of the tooth, and determining the angle of the dental file relative to the top surface of the tooth.

At step 610, a positioning of the dental file relative to the corresponding tooth in the X-ray image is determined. In this step, the tooth and its root(s) are segmented in the X-ray image. Also in this step, the positioning of the dental file relative to the tooth in the X-ray image is determined.

At step 612, a representation of the dental image is depicted in the X-ray image. The representation of the dental file is scaled relative to the size of the tooth in the X-ray image. The representation of the tooth is positioned based on the determinations made in steps 608 and 610. As such, the image depicts the representation of a dental file with the proportional part of the dental file extending from the upper surface of the tooth and the proportional part of the dental file extending into the canal of the tooth. The dental file is also positioned at the determined angle relative to the upper surface of the tooth.

At step 614, the X-ray image with the added representation of the dental file is displayed.

Further aspects of the apparatuses, systems, and methods described above may be implemented as an article of manufacture such as a non-transitory computer readable storage medium. The non-transitory computer readable storage medium may be readable by a computer and may comprise instructions for causing the computer to perform functions described herein. The non-transitory computer readable storage medium may be implemented by a volatile computer memory, non-volatile computer memory/storage, hard drive, solid-state memory, flash drive, removable disk and/or other media.

With the apparatuses, systems, and methods described above, a dental professional can easily generate an image (e.g., an X-ray) to determine the positioning of a dental file in a tooth during an endodontic procedure. Unlike prior techniques, the image can be generated with minimal actions on the part of the patient. For example, the patient need not be move from an operating chair to another place for taking an X-ray. Thus, the dental file position determination enabled by apparatuses, systems, and methods according to embodiments to the invention is convenient for both a professional and a patient. Further, the patient avoids radiation exposure from an X-ray taken for the sole purpose of determining the position of the dental file.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to best explain the principles of embodiments of the invention and its practical applications, to thereby enable others skilled in the art to best utilize embodiments of the invention and various implementations with various modifications as are suited to the particular use contemplated.

1. A method of providing an image depicting a representation of a dental file extending into a root of a tooth, the method comprising:
obtaining data showing morphology of the tooth;
generating a three-dimensional representation of the dental file positioned in the tooth;
determining from the three-dimensional representation a length that the dental file extends from an upper surface of the tooth;
providing a representation of the dental file in an image of the tooth generated from the data showing the morphology of the tooth, with the representation of the dental file being depicted in the image such that a part of the representation of the dental file extends from the upper surface of the tooth in proportion to the length that the dental file extends from the upper surface of the tooth as determined from the three-dimensional representation and such that a remaining part of the representation of the dental file extends into the tooth, with a part of the remaining part of the representation of the dental file being positioned in the root of the tooth in the image; and
displaying the image of tooth and representation of the dental file.

2. The method according to claim 1, wherein the data showing the morphology of the tooth is X-ray image data obtained before the dental file is positioned in the tooth and the image of the tooth is the X-ray image.

3. The method according to claim 1, wherein the three-dimensional representation is generated by an intraoral digital impression scanner.

4. The method according to claim 1, wherein the dental file includes at least one of a marker on a surface of the dental file that is used in determining the length that the dental file extends from the upper surface of the tooth from the three-dimensional representation.

5. The method according to claim 1, further comprising determining from the three-dimensional representation an angle of the dental file relative to the upper surface of the tooth, wherein the representation of the dental file in the image is depicted such that the representation of the dental file is at the determined angle relative to the upper surface of the tooth.

6. An apparatus for providing an image depicting a representation of a dental file positioned in a root of a tooth, the apparatus comprising:
at least one processor configured to read out and execute instructions stored in at least one memory to thereby cause the apparatus to function as:
a receiving unit configured to receive (i) data showing morphology of the tooth, and (ii) a three-dimensional representation of a dental file and the tooth;
a file position determining unit configured to determine from the three-dimensional representation a length that the dental file extends from an upper surface of the tooth; and
an image generation unit configured to provide a representation of the dental file in an image of the tooth, with the representation of the dental file being depicted in the image such that a part of the representation of the dental file extends from the upper surface of the tooth in proportion to the length that the dental file extends from the upper surface of the tooth as determined from the three-dimensional representation and such that a remaining part of the representation of the dental file extends into the tooth, with a part of the remaining part of the representation of the dental file being positioned in the root of the tooth.

7. The apparatus according to claim 6, wherein the data showing the morphology of the tooth is an X-ray image data obtained before the dental file is positioned in the tooth and the image of the tooth is the X-ray image.

8. The apparatus according to claim 7, wherein the three-dimensional representation is generated by an intraoral digital impression scanner.

9. The apparatus according to claim 7, wherein the dental file includes at least one of a marker on a surface of the dental file that is used in determining the length that the dental file extends from the upper surface of the tooth from the three-dimensional representation.

10. The apparatus according to claim ,7 wherein the file position determining unit is further configured to determine from the three-dimensional representation an angle of the dental file relative to the upper surface of the tooth, and
wherein the image generation unit is further configured to provide the representation of the dental file in the image such that the representation of the dental file is at the determined angle relative to the upper surface of the tooth.

11. The apparatus according to claim 7, further comprising a display device configured to display the X-ray image with the representation of the dental file.
